(19) United States
(12) Patent Application Publication
(10) Pub. No.: US 2025/0009590 A1
(43) Pub. Date: Jan. 9, 2025

(54) WALKER HAVING STRUCTURE CAPABLE OF BEING FOLDED TWICE

(71) Applicant: ORBITN CO., LTD., Seoul (KR)

(72) Inventor: Kyungae CHA, Seoul (KR)

(21) Appl. No.: 18/228,693

(22) Filed: Aug. 1, 2023

(30) Foreign Application Priority Data
Jul. 4, 2023 (KR) 10-2023-0086472

(51) Int. Cl. A61H 3/04

(52) U.S. Cl. CPC A61H 3/04; A61H 2003/046; A61H 2201/0161; A61H 2201/0192; A61H 2201/1635

(57) ABSTRACT

A disclosed walking assist apparatus may include first and second main frames spaced apart from each other, extending in parallel in an upward/downward direction, first and second front wheel parts respectively coupled to front ends of the first and second lower support frames or portions adjacent to the front ends of the first and second lower support frames, and an X-shaped connection member disposed between the first and second main frames to connect the first and second main frames and having first and second connection frames disposed to intersect each other in an X shape.

### CROSS-REFERENCE TO RELATED APPLICATION

This application claims priority to and the benefit of Korean Patent Application No. 10-2023-0086472 filed in the Korean Intellectual Property Office on Jul. 4, 2023, the entire contents of which are incorporated herein by reference.

### BACKGROUND

### Technical Field

The present invention relates to a device and method related to walking/mobility, and more particularly, to a walker and a related method that old and weak persons may use.

### Related Art

With the rapid increase in population of old people, it is expected that industries and related markets, which provide goods or services to old people, will be significantly expanded. There is a rapidly increasing demand for products that support/assist independent living/activities of old and weak persons or are required for exercise, injury prevention, and the like. A walking assistant, which is a mobility assistant, is one of the products. The walking assistants are products that are required not only by old people who suffer from aging symptoms such as weakness of muscular strength of lower limb and waist, poor balance, and musculoskeletal diseases, but also by persons who need walking assistance due to injuries or the like. The demand for a walking assistant is consistently increasing.

However, the walking assistant in the related art mostly has a structure configured by connecting steel frames, occupies a significantly large volume, and is comparatively vulnerable to impact. For this reason, the walking assistant may have many disadvantages in terms of logistical movements such as transportation, delivery, and shipping. In addition, from the point of view of the user, the walking assistant needs to be compactly accommodated and stored. However, the walking assistant in the related art may hardly satisfy the requirements of the consumer. Further, the walking assistant in the related art may have a problem in which the convenience of use and safety deteriorate.

Accordingly, there is a need to develop a walking assist apparatus capable of ensuring the convenience of use and safety and having advantages in terms of logistical movements, accommodation, and storage.

### SUMMARY

The present invention has been made in an effort to provide a walking assist apparatus capable of ensuring the convenience of use and safety and having significant advantages in terms of logistical movements, accommodation, and storage.

Technical problems to be solved by the present invention are not limited to the above-mentioned technical problems, and other technical problems, which are not mentioned above, may be clearly understood by those skilled in the art from the following descriptions.

To achieve the above-mentioned object, the present invention provides a walking assist apparatus having a structure capable of being folded twice, the walking assist apparatus including: first and second main frames spaced apart from each other, extending in parallel in an upward/downward direction, and having first and second handle parts provided at upper ends of the first and second main frames or portions adjacent to the upper ends of the first and second main frames; first and second lower support frames respectively rotatably coupled to lower ends of the first and second main frames and extending in parallel in a forward/rearward direction; first and second front wheel parts respectively coupled to front ends of the first and second lower support frames or portions adjacent to the front ends of the first and second lower support frames; first and second rear wheel parts respectively coupled to rear ends of the first and second lower support frames or portions adjacent to the rear ends of the first and second lower support frames; and an X-shaped connection member disposed between the first and second main frames to connect the first and second main frames and having first and second connection frames disposed to intersect each other in an X shape, in which the first and second lower support frames are configured to be folded by being rotated toward rear sides of the first and second main frames, and the X-shaped connection member is configured to be folded so that the first and second main frames are adjacent to each other.

The first and second main frames may be disposed to be inclined with respect to a vertical direction toward sides at which the first and second handle parts are disposed, and the first and second lower support frames may be disposed to be inclined with respect to a horizontal direction so that front ends of the first and second lower support frames are disposed at positions higher than positions of rear ends of the first and second lower support frames.

The walking assist apparatus may further include: first and second wheel coupling members respectively coupled to front ends of the first and second lower support frames or portions adjacent to the front ends of the first and second lower support frames and extending downward, in which the first and second front wheel parts are respectively coupled to and installed on the first and second wheel coupling members.

The first and second front wheel parts may be respectively disposed below the first and second lower support frames, the first and second rear wheel parts may be respectively disposed outside the first and second lower support frames in a transverse direction, and the first and second rear wheel parts may be respectively disposed to overlap the first and second main frames in the transverse direction when the first and second lower support frames are folded by being rotated toward rear sides of the first and second main frames.

The walking assist apparatus may further include: a first coupling member disposed between the first connection frame and the first main frame to connect the first connection frame and the first main frame and configured to be bent by an operation of folding the X-shaped connection member; a second coupling member disposed between the second connection frame and the second main frame to connect the second connection frame and the second main frame and configured to be bent by the operation of folding the X-shaped connection member; and a locking member installed on at least one of the first and second coupling members and configured to lock or unlock the operation of folding the X-shaped connection member.

The locking member may include a hook portion, at least one of the first and second connection frames may include a protrusion portion, and the operation of folding the X-shaped connection member may be locked or unlocked as the hook portion is caught by or released from the protrusion portion.

The walking assist apparatus may further include: a first extension rod coupled to an upper end of the first connection frame and extending in the forward/rearward direction; a second extension rod coupled to an upper end of the second connection frame and extending in the forward/rearward direction; and a support member disposed to connect the first and second extension rods and having flexibility.

The walking assist apparatus may further include an auxiliary band member provided above the support member, connected to the first and second main frames, and having a structure formed convexly forward with respect to the first and second main frames.

The walking assist apparatus may further include: a first brake lever disposed on a portion of the first main frame disposed below the first handle part and configured to brake the first rear wheel part; and a second brake lever disposed on a portion of the second main frame disposed below the second handle part and configured to brake the second rear wheel part.

According to the embodiments of the present invention, it is possible to implement the walking assist apparatus capable of ensuring the convenience of use and safety and having significant advantages in terms of logistical movements, accommodation, and storage. The walking assist apparatus according to the embodiments has the double foldable structure, i.e., the structure capable of being folded twice, which may provide many advantages in terms of logistical movements such as shipping, delivery, and transportation and enable compact accommodation/storage even for the user. Further, the walking assist apparatus according to the embodiments may provide excellent convenience of use and safety.

However, the effect of the present invention is not limited to the above-mentioned effects but may be variously expanded without departing from the technical spirit and scope of the present invention.

### BRIEF DESCRIPTION OF THE DRAWINGS

FIG. 1 is a perspective view illustrating a walking assist apparatus having a structure capable of being folded twice according to an embodiment of the present invention.

FIG. 2 is a perspective view illustrating the walking assist apparatus having the structure capable of being folded twice according to the embodiment of the present invention.

FIG. 3 is a perspective view illustrating the walking assist apparatus having the structure capable of being folded twice according to the embodiment of the present invention.

FIG. 4 is a perspective view illustrating the walking assist apparatus having the structure capable of being folded twice according to the embodiment of the present invention.

FIG. 5 is a perspective view illustrating a state in which the walking assist apparatus according to the embodiment of the present invention is folded.

FIG. 6 is a perspective view illustrating a state in which the walking assist apparatus according to the embodiment of the present invention is folded.

FIG. 7 is a perspective view illustrating a state in which the walking assist apparatus according to the embodiment of the present invention is folded.

FIG. 8 is a perspective view illustrating a state in which the walking assist apparatus according to the embodiment of the present invention is folded.

### DETAILED DESCRIPTION

Hereinafter, embodiments of the present invention will be described in detail with reference to the accompanying drawings.

The embodiments of the present invention to be described below are provided to more clearly explain the present invention to those skilled in the art. The scope of the present invention is not limited to the following embodiments, and the following embodiments may be modified in various other forms.

The terms used in the present specification are for explaining the particular embodiments, not for limiting the present invention. The singular expressions used in the present specification may include the plural expressions unless the context clearly dictates otherwise. The terms “comprise (include)” and/or “comprising (including)” used in the present specification are intended to specify the presence of the mentioned shapes, steps, numbers, operations, members, elements, and/or groups thereof, but do not exclude presence or addition of one or more other shapes, steps, numbers, operations, members, elements, and/or groups thereof. In addition, the terms “connected,” “connecting.” and the like used in the present specification are intended to mean not only that certain members are directly connected, but also that the members are indirectly connected as another member is further interposed between the members.

In the specification of the present application, when one member is disposed “on” another member, this includes not only a case where the one member is brought into contact with another member, but also a case where still another member is present between the two members. The term “and/or” used in the present specification includes any one, one or more, or all the combinations of listed related items. Words of degree, such as “about”, “substantially”, and the like are used throughout the specification of the present application in the sense of “at, or nearly at, when given the manufacturing, design, and material tolerances inherent in the stated circumstances” and are used to prevent the infringer from unfairly taking advantage of the present invention where exact or absolute figures and operational or structural relationships are stated as an aid to understanding the present invention.

Hereinafter, the embodiments of the present invention will be described in detail with reference to the accompanying drawings. The sizes or thicknesses of the regions or parts illustrated in the accompanying drawings may be somewhat exaggerated for the clarity of the specification and the convenience of description. Throughout the detailed description, like reference numerals indicate like components throughout the specification.

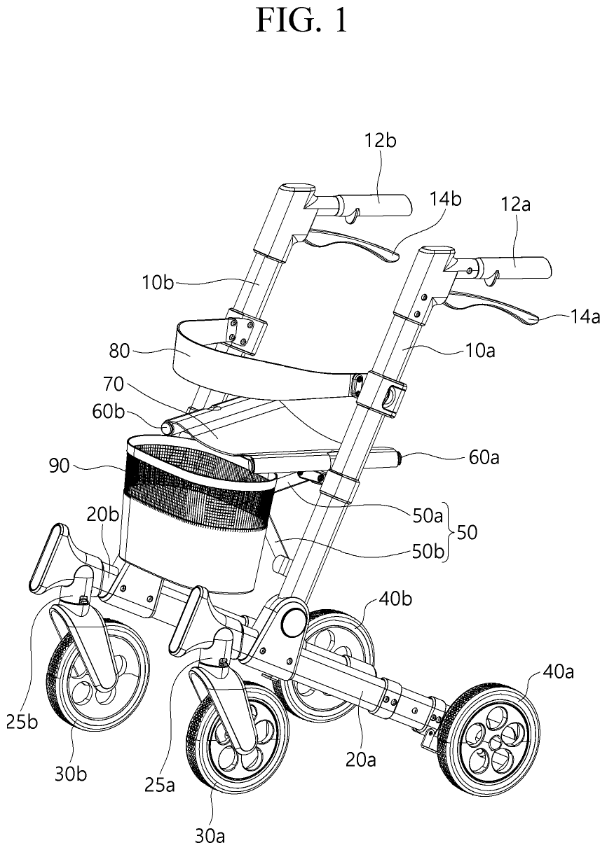

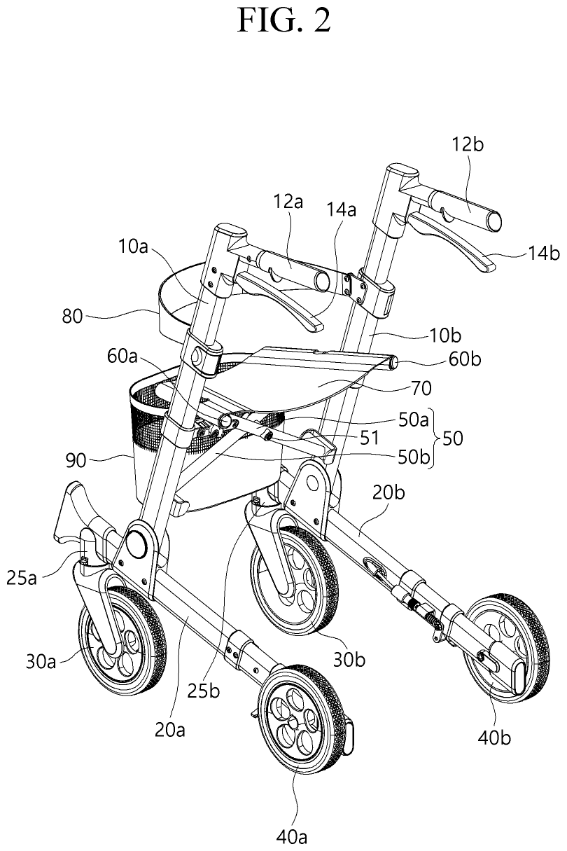

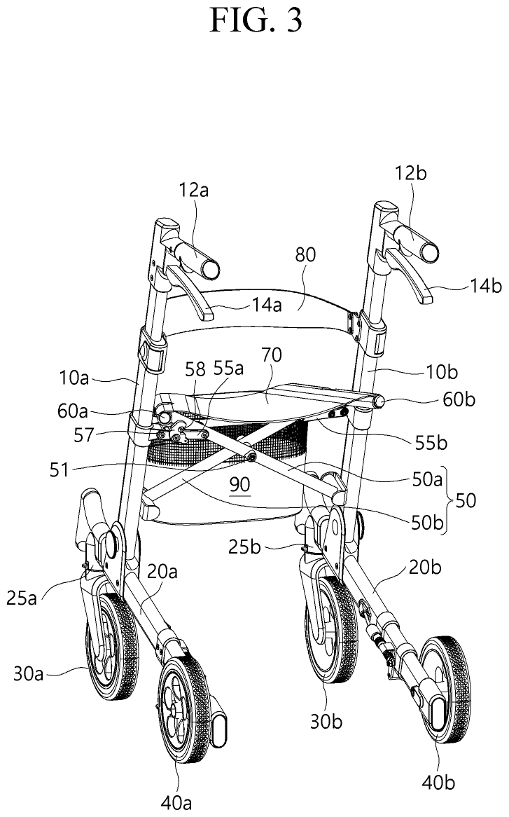

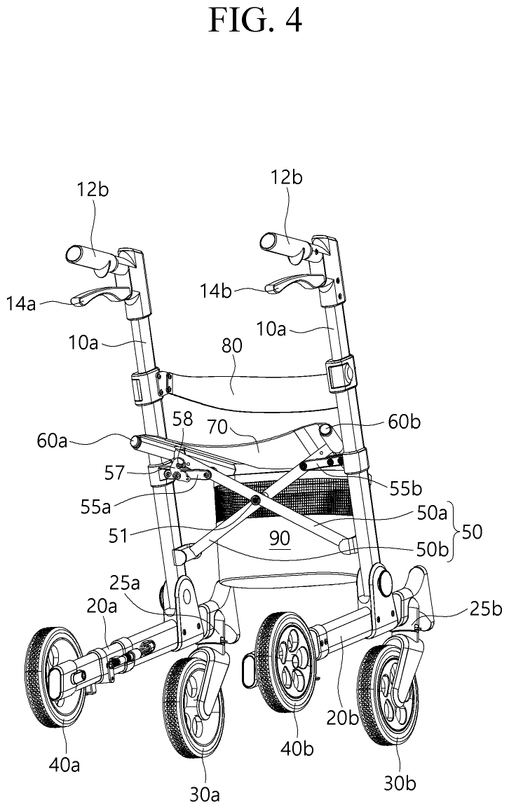

FIGS. 1 to 4 are perspective views illustrating a walking assist apparatus having a structure capable of being folded twice according to an embodiment of the present invention. FIGS. 1 to 4 illustrates the walking assist apparatus in a non-folded state. The walking assist apparatus may be referred to as a ‘walker’ or ‘walking assistant’.

With reference to FIGS. 1 to 4, the walking assist apparatus according to the embodiment of the present invention may include first and second main frames 10a and 10b spaced apart from each other, extending in parallel in an upward/downward direction, and having first and second handle parts 12a and 12b provided at upper ends of the first and second main frames 10a and 10b or portions adjacent to the upper ends of the first and second main frames 10a and 10b. The first main frame 10a may be referred to as a first main column part or a first main column frame part, and the second main frame 10b may be referred to as a second main column part or a second main column frame part. In some instances, the first and second handle parts 12a and 12b may be connected to each other or integrated.

The walking assist apparatus may include first and second lower support frames 20a and 20b respectively coupled to lower ends of the first and second main frames 10a and 10b and extending in parallel in a forward/rearward direction. The first and second lower support frames 20a and 20b may be respectively coupled to the lower ends of the first and second main frames 10a and 10b so as to be rotatable relative to the first and second main frames 10a and 10b. The first lower support frame 20a may be referred to as a first lower support rod, and the second lower support frame 20b may be referred to as a second lower support rod.

The walking assist apparatus may include first and second front wheel parts 30a and 30b respectively coupled (connected) to front ends of the first and second lower support frames 20a and 20b or portions adjacent to the front ends of the first and second lower support frames 20a and 20b. In addition, the walking assist apparatus may include first and second rear wheel parts 40a and 40b respectively coupled (connected) to rear ends of the first and second lower support frames 20a and 20b or portions adjacent to the rear ends of the first and second lower support frames 20a and 20b.

The walking assist apparatus may include an X-shaped connection member 50 disposed between the first and second main frames 10a and 10b to connect the first and second main frames 10a and 10b. The X-shaped connection member 50 may include first and second connection frames 50a and 50b disposed to intersect each other in an X shape. The first connection frame 50a may be referred to as a first connection rod, and the second connection frame 50b may be referred to as a second connection rod. A middle portion of the first connection frame 50a and a middle portion of the second connection frame 50b may be coupled to each other by a coupling pin 51. The X-shaped connection member 50 may be folded or unfolded as the first and second connection frames 50a and 50b rotate in opposite directions about the coupling pin 51. The coupling pin 51 may be considered as a constituent element included in the X-shaped connection member 50.

The walking assist apparatus according to the embodiment of the present invention may be configured such that the first and second lower support frames 20a and 20b may be folded by being rotated toward rear sides of the first and second main frames 10a and 10b, and the X-shaped connection member 50 may be folded so that the first and second main frames 10a and 10b approach each other (are disposed adjacent to each other). Therefore, the walking assist apparatus may have a structure capable of being folded twice, such that the walking assist apparatus may be folded in a significantly compact manner. It can be said that the walking assist apparatus has a double collapsible structure (a twice-foldable structure or a double-foldable structure).

According to the embodiment, the first and second main frames 10a and 10b may be disposed to be inclined with respect to a vertical direction toward a side at which the first and second handle parts 12a and 12b are disposed. In other words, the first and second main frames 10a and 10b may be disposed to be inclined at a predetermined angle toward a side at which a user (pedestrian) is positioned. For example, the first and second main frames 10a and 10b may be disposed to define a predetermined acute angle with respect to a vertical line. This is based on a case in which the first and second front wheel parts 30a and 30b and the first and second rear wheel parts 40a and 40b are disposed on a horizontal plane. In addition, the first and second lower support frames 20a and 20b may be disposed to be inclined with respect to the horizontal direction so that the front ends of the first and second lower support frames 20a and 20b are disposed at positions higher than the positions of the rear ends of the first and second lower support frames 20a and 20b. The front ends of the first and second lower support frames 20a and 20b may be disposed at positions higher, to some extent, than the positions of the rear ends of the first and second lower support frames 20a and 20b. The first and second lower support frames 20a and 20b may be disposed to define a predetermined acute angle with respect to a horizontal line. This is based on a case in which the first and second front wheel parts 30a and 30b and the first and second rear wheel parts 40a and 40b are disposed on the horizontal plane. In addition, the first lower support frame 20a may be disposed to perpendicular or substantially perpendicular to the first main frame 10a, and the second lower support frame 20b may be disposed to perpendicular or substantially perpendicular to the second main frame 10b.

According to the embodiment, the walking assist apparatus may further include first and second wheel coupling members 25a and 25b respectively coupled to front ends of the first and second lower support frames 20a and 20b or portions adjacent to the front ends of the first and second lower support frames 20a and 20b and extending downward. In this case, the first and second front wheel parts 30a and 30b may be respectively coupled to and installed on the first and second wheel coupling members 25a and 25b. The first and second front wheel parts 30a and 30b may be rotatably provided on the first and second wheel coupling members 25a and 25b. Therefore, the traveling direction may be easily changed when the walking assist apparatus is used.

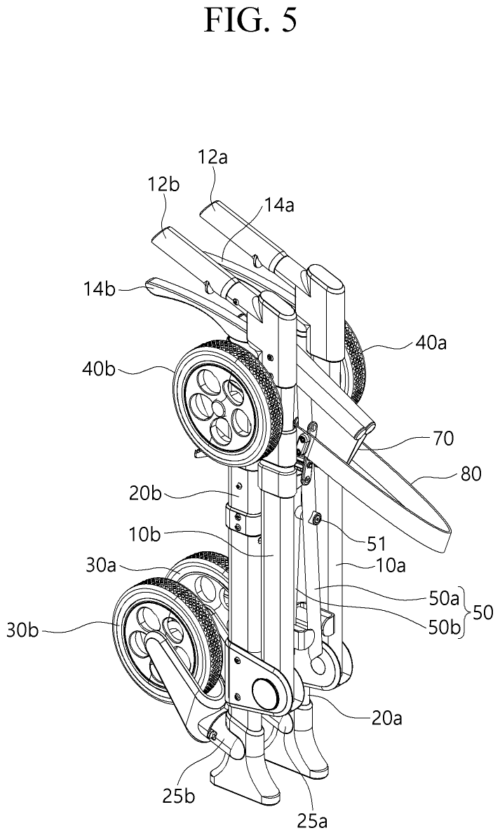

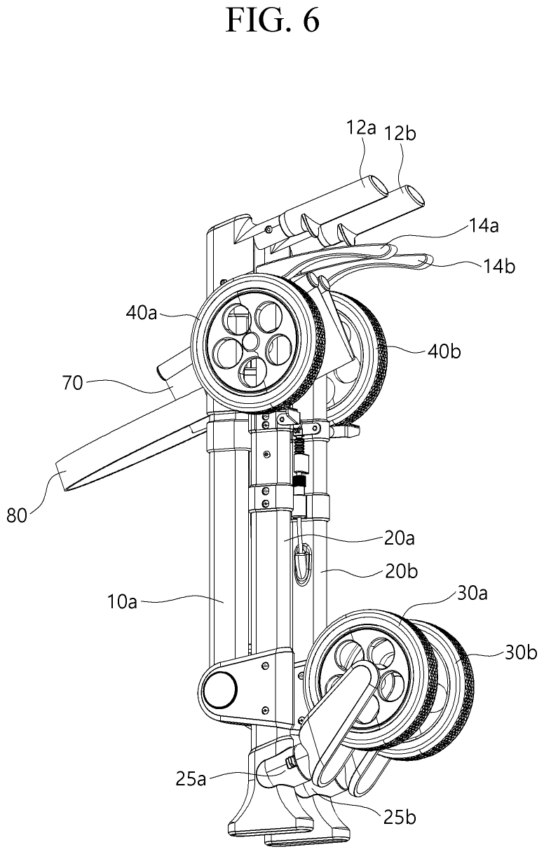

According to the embodiment, the first and second front wheel parts 30a and 30b may be respectively disposed below (immediately below) the first and second lower support frames 20a and 20b, and the first and second rear wheel parts 40a and 40b may be disposed outside the first and second lower support frames 20a and 20b in a transverse direction. The first rear wheel part 40a may be disposed outside the first lower support frame 20a in the transverse direction, and the second rear wheel part 40b may be disposed outside the second lower support frame 20b in the transverse direction. The first rear wheel part 40a may be disposed outside the first lower support frame 20a in the transverse direction and protrude downward while overlapping the first lower support frame 20a in the transverse direction, and the second rear wheel part 40b may be disposed outside the second lower support frame 20b in the transverse direction and protrude downward while overlapping the second lower support frame 20b in the transverse direction. Therefore, the first and second rear wheel parts 40a and 40b may be disposed to overlap the first and second main frames 10a and 10b in the transverse direction when the first and second lower support frames 20a and 20b are folded by being rotated toward the first and second main frames 10a and 10b (see FIGS. 5 and 6).

According to the embodiment, the walking assist apparatus may further include a first coupling member 55a disposed between the first connection frame 50a of the X-shaped connection member 50 and the first main frame 10a to connect the first connection frame 50a and the first main frame 10a, and a second coupling member 55b disposed between the second connection frame 50b of the X-shaped connection member 50 and the second main frame 10b to connect the second connection frame 50b and the second main frame 10b. The first coupling member 55a may be configured to be bent by the operation of folding the X-shaped connection member 50. Similarly, the second coupling member 55b may be configured to be bent by the operation of folding the X-shaped connection member 50. The first coupling member 55a may be disposed to connect and couple the first main frame 10a and a portion adjacent to an upper end of the first connection frame 50a, and the second coupling member 55b may be disposed to connect and couple the second main frame 10b and a portion adjacent to an upper end of the second connection frame 50b. A lower end of the first connection frame 50a may be rotatably coupled to the second main frame 10b, and a lower end of the second connection frame 50b may be rotatably coupled to the first main frame 10a.

The walking assist apparatus may further include a locking member 57 installed on at least one of the first and second coupling members 55a and 55b. In this case, the locking member 57 is illustrated as being installed on the first coupling member 55a. The locking member 57 may be configured to lock or unlock the operation of folding the X-shaped connection member 50.

According to the specific embodiment, the locking member 57 may include a hook portion, and at least one of the first and second connection frames 50a and 50b, e.g., the first connection frame 50a may include a protrusion portion 58. As the hook portion is caught by the protrusion portion 58 or released, the operation of folding the X-shaped connection member 50 may be locked or unlocked. Therefore, a user may lock or unlock the operation of folding the X-shaped connection member 50 by using the locking member 57. Therefore, the user may enable the X-shaped connection member 50 to be folded only when necessary. Therefore, the convenience of use and safety may be improved. The number, position, and specific structure of the locking member 57 may be variously modified without being limited to the above-mentioned configuration.

In addition, a separate locking device capable of locking or unlocking the operation of folding the first and second lower support frames 20a and 20b may be further provided. For example, the user may unlock the first and second lower support frames 20a and 20b by pushing a predetermined button-type locking part and then fold the first and second lower support frames 20a and 20b toward the first and second main frames 10a and 10b. Alternatively, the first and second lower support frames 20a and 20b may be configured to be folded only in case that an external force higher than a critical force is applied.

According to the embodiment, the walking assist apparatus may further include a first extension rod 60a coupled to the upper end of the first connection frame 50a and extending in the forward/rearward direction, a second extension rod 60b coupled to the upper end of the second connection frame 50b and extending in the forward/rearward direction, and a support member 70 disposed to connect the first and second extension rods 60a and 60b and having flexibility. The support member 70 may have a shape similar to a shape of a saddle or seat. A predetermined item may be placed on the support member 70, or a person may be seated on the support member 70, when necessary. The support member 70 may be made of a flexible material and bent flexibly.

In addition, the walking assist apparatus may further include an auxiliary band member 80 provided above the support member 70 and connected to the first and second main frames 10a and 10b. The auxiliary band member 80 may have a structure formed to be convex forward with respect to the first and second main frames 10a and 10b. In case that an item is placed on the support member 70 or a person is seated on the support member 70, the auxiliary band member 80 may serve to support the item or person at the front side. The auxiliary band member 80 may also be made of a flexible material and bent flexibly. The support member 70 and the auxiliary band member 80 may serve to further improve the convenience of use and safety of the walking assist apparatus.

According to the embodiment, the walking assist apparatus may further include a first brake lever 14a disposed on a portion of the first main frame 10a disposed below the first handle part 12a and configured to brake the first rear wheel part 40a, and a second brake lever 14b disposed on a portion of the second main frame 10b disposed below the second handle part 12b and configured to brake the second rear wheel part 40b. When walking, the user, as necessary, may brake at least one of the first and second rear wheel parts 40a and 40b by using at least one of the first and second brake levers 14a and 14b. In addition, in addition to the first and second brake levers 14a and 14b, at least one locking member capable of locking a movement of at least one of the first and second rear wheel parts 40a and 40b may be further provided. The locking member may be configured to be operated by the user's foot or hand. In addition, in case that the user locks at least one of the first and second rear wheel parts 40a and 40b by using the locking member, the locking state may be maintained until the locking state is released.

According to the embodiment, the walking assist apparatus may further include a storage member 90 capable of accommodating items or the like. For example, the storage member 90 may be disposed forward of the X-shaped connection member 50. The storage member 90 may be disposed by being coupled to the X-shaped connection member 50 and provided in the form of a basket, a box, a pocket, a bag, or the like. The storage member 90 may be configured to be detachable (easily detached) from the walking assist apparatus. Therefore, the storage member 90 may be easily removed in some circumstances.

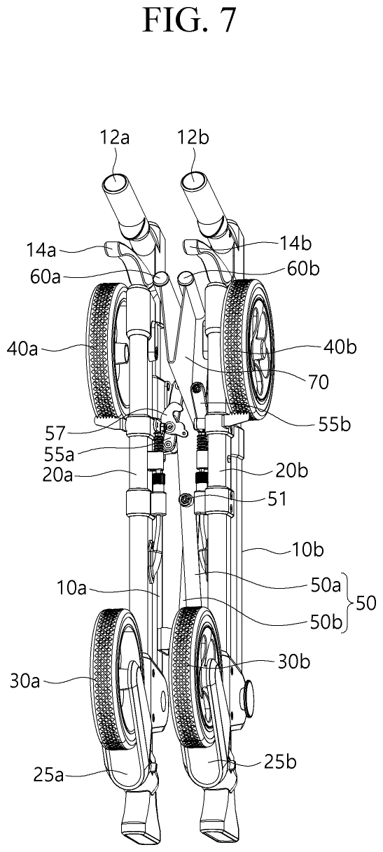

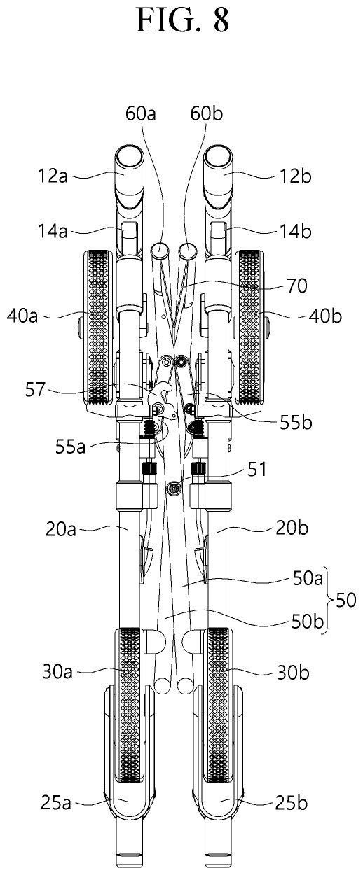

FIGS. 5 to 8 are perspective views illustrating a state in which the walking assist apparatus according to the embodiment of the present invention is folded (folded twice).

With reference to FIGS. 5 to 8, the walking assist apparatus according to the present embodiment may be configured such that the first and second lower support frames 20a and 20b may be folded by being rotated toward the rear sides of the first and second main frames 10a and 10b, and the X-shaped connection member 50 may be folded so that the first and second main frames 10a and 10b approach each other (are disposed adjacent to each other). That is, the walking assist apparatus may have a structure capable of being folded twice. The first and second lower support frames 20a and 20b may be folded toward the rear sides of the first and second main frames 10a and 10b and be in close contact with and parallel to the first and second main frames 10a and 10b. In addition, when the X-shaped connection member 50 is folded, the first and second main frames 10a and 10b may be disposed to be significantly adjacent to each other. Therefore, the walking assist apparatus may be folded in a significant compact manner. It can be said that the walking assist apparatus has a double collapsible structure.

According to the embodiment, as illustrated in FIGS. 5 and 6, the first and second rear wheel parts 40a and 40b may be disposed to overlap the first and second main frames 10a and 10b in the transverse direction when the first and second lower support frames 20a and 20b are folded by being rotated toward the first and second main frames 10a and 10b. With this structure, the first and second lower support frames 20a and 20b may be respectively in close contact with and parallel to the first and second main frames 10a and 10b, such that a more compact and stable folded state may be implemented.

According to the embodiment, the walking assist apparatus may have a predetermined sensor and an electronic brake device. A function of improving pedestrian safety is provided on the basis of the sensor.

According to an example, pressure sensors may be provided in the first front wheel part 30a, the second front wheel part 30b, the first rear wheel part 40a, and the second rear wheel part 40b. The first front wheel part 30a, the second front wheel part 30b, the first rear wheel part 40a, and the second rear wheel part 40b may be controlled on the basis of pressure acquired by the provided pressure sensors. More specifically, the first rear wheel part 40a and the second rear wheel part 40b may be braked so as not to rotate in case that an average value of a first pressure acquired by a first pressure sensor provided in the first front wheel part 30a and a second pressure acquired by a second pressure sensor provided in the second front wheel part 30b is a first critical value or less and an average value of a third pressure acquired by a third pressure sensor provided in the first rear wheel part 40a and a fourth pressure acquired by a fourth pressure sensor provided in the second rear wheel part 40b is a second critical value or more. Therefore, when a pedestrian falls down backward while holding the handle parts 12a and 12b, the above-mentioned pressure distribution may occur on the wheel parts. In this case, the first rear wheel part 40a and the second rear wheel part 40b may be automatically braked so as not to rotate, thereby improving the stability of the pedestrian.

In another embodiment, the first front wheel part 30a and the second front wheel part 30b may be braked so as not to rotate in case that the average value of the first pressure acquired by the first pressure sensor provided in the first front wheel part 30a and the second pressure acquired by the second pressure sensor provided in the second front wheel part 30b is the third critical value or more and the average value of the third pressure acquired by the third pressure sensor provided in the first rear wheel part 40a and the fourth pressure acquired by the fourth pressure sensor provided in the second rear wheel part 40b is the fourth critical value or less. In this case, the front wheels are braked in a situation in which a pedestrian falls down forward on a downward slope or the like, thereby providing a means capable of improving the stability of the pedestrian.

According to another example, the walking assist apparatus electronically brakes the first front wheel part 30a, the second front wheel part 30b, the first rear wheel part 40a, and the second rear wheel part 40b on the basis of a walking pattern of the pedestrian, thereby providing the safety to the user. More specifically, the walking assist apparatus may determine an average walking speed of the pedestrian through the walking pattern of the pedestrian on the basis of a provided speed sensor (e.g., a sensor provided in the wheel and configured to detect a rotational speed for each time). In case that a real-time speed of the walking assist apparatus is higher than an average walking speed of the pedestrian by a predetermined critical value or more, the first front wheel part 30a, the second front wheel part 30b, the first rear wheel part 40a, and the second rear wheel part 40b may be electronically braked at a predetermined level, thereby allowing the pedestrian to walk within a predetermined speed range. In this process, the walking assist apparatus is braked by the acceleration with a predetermined magnitude or lower, thereby providing a means capable of allowing the pedestrian to walk while gradually decreasing the speed.

According to still another example, gravity sensors may be provided in the first front wheel part 30a, the second front wheel part 30b, the first rear wheel part 40a, and the second rear wheel part 40b. The first front wheel part 30a, the second front wheel part 30b, the first rear wheel part 40a, and the second rear wheel part 40b may be controlled on the basis of pressure acquired by the gravity sensors provided in the walking assist apparatus. More specifically, in case that it is determined by the gravity sensors that positions of the first front wheel part 30a and the second front wheel part 30b are higher than positions of the first rear wheel part 40a and the second rear wheel part 40b by a predetermined critical value or more, the walking assist apparatus may support the walking of the pedestrian, who moves on an upward slope, by providing predetermined power to the first front wheel part 30a, the second front wheel part 30b, the first rear wheel part 40a, and the second rear wheel part 40b.

On the contrary, in case that it is determined by the gravity sensors that the positions of the first front wheel part 30a and the second front wheel part 30b are lower than the positions of the first rear wheel part 40a and the second rear wheel part 40b by a predetermined critical value or more, the walking assist apparatus may provide a means for assisting the safety of the pedestrian, who moves downward on a downward slope, by braking the first front wheel part 30a, the second front wheel part 30b, the first rear wheel part 40a, and the second rear wheel part 40b at a predetermined level.

In case that a rate of change in pressure detected by the pressure sensors in the first front wheel part 30a, the second front wheel part 30b, the first rear wheel part 40a, and the second rear wheel part 40b is detected in a predetermined cycle or more, the walking assist apparatus may assist the safety of the pedestrian, who walks on a road with an uneven road surface, by braking the first front wheel part 30a, the second front wheel part 30b, the first rear wheel part 40a, and the second rear wheel part 40b at a predetermined level.

In case that a force for braking exceeds a predetermined braking force critical value (here, the braking force critical value is determined as a value smaller than a maximum braking force) during an electronic braking process, the walking assist apparatus may generate notification sound, thereby preventing a situation in which the pedestrian cannot be braked.

The walking assist apparatus may further include a predetermined computing device that may operate in response to a signal or the like. The walking assist apparatus may brake the wheel part in a situation (e.g., red light) in which the pedestrian cannot walk in response to a signal or the like, thereby providing the function of supporting the safety of the pedestrian.

According to the embodiments of the present invention described above, it is possible to implement the walking assist apparatus capable of ensuring the convenience of use and safety and having significant advantages in terms of logistical movements, accommodation, and storage. The walking assist apparatus according to the embodiments has the double foldable structure, i.e., the structure capable of being folded twice, which may provide many advantages in terms of logistical movements such as shipping, delivery, and transportation and enable compact accommodation/storage even for the user. Further, the walking assist apparatus according to the embodiments may provide excellent convenience of use and safety.

The exemplary embodiments of the present invention have been disclosed in the present specification, and specific terms are used, but the specific terms are used as general meanings merely for easily explaining the technical contents of the present invention and helping understand the present invention, but not intended to limit the scope of the present invention. It is obvious to those skilled in the art to which the present invention pertains that other modified embodiments may be carried out based on the technical spirit of the present invention in addition to the exemplary embodiments disclosed herein. For example, those skilled in the art may recognize that the walking assist apparatus according to the embodiments described with reference to FIGS. 1 to 8 may be modified variously. Therefore, the scope of the present invention should be determined by the technical spirit of the appended claims instead of being determined by the described embodiment.

What is claimed is:

1. A walking assist apparatus having a structure capable of being folded twice, the walking assist apparatus comprising:
first and second main frames spaced apart from each other, extending in parallel in an upward/downward direction, and having first and second handle parts provided at upper ends of the first and second main frames or portions adjacent to the upper ends of the first and second main frames;
first and second lower support frames respectively rotatably coupled to lower ends of the first and second main frames and extending in parallel in a forward/rearward direction;
first and second front wheel parts respectively coupled to front ends of the first and second lower support frames or portions adjacent to the front ends of the first and second lower support frames;
first and second rear wheel parts respectively coupled to rear ends of the first and second lower support frames or portions adjacent to the rear ends of the first and second lower support frames; and
an X-shaped connection member disposed between the first and second main frames to connect the first and second main frames and having first and second connection frames disposed to intersect each other in an X shape,
wherein the first and second lower support frames are configured to be folded by being rotated toward rear sides of the first and second main frames, and the X-shaped connection member is configured to be folded so that the first and second main frames are adjacent to each other.

2. The walking assist apparatus of claim 1, wherein the first and second main frames are disposed to be inclined with respect to a vertical direction toward sides at which the first and second handle parts are disposed, and the first and second lower support frames are disposed to be inclined with respect to a horizontal direction so that front ends of the first and second lower support frames are disposed at positions higher than positions of rear ends of the first and second lower support frames.

3. The walking assist apparatus of claim 2, further comprising:
first and second wheel coupling members respectively coupled to front ends of the first and second lower support frames or portions adjacent to the front ends of the first and second lower support frames and extending downward,
wherein the first and second front wheel parts are respectively coupled to and installed on the first and second wheel coupling members.

4. The walking assist apparatus of claim 1, wherein the first and second front wheel parts are respectively disposed below the first and second lower support frames, the first and second rear wheel parts are respectively disposed outside the first and second lower support frames in a transverse direction, and the first and second rear wheel parts are respectively disposed to overlap the first and second main frames in the transverse direction when the first and second lower support frames are folded by being rotated toward rear sides of the first and second main frames.

5. The walking assist apparatus of claim 1, further comprising:
a first coupling member disposed between the first connection frame and the first main frame to connect the first connection frame and the first main frame and configured to be bent by an operation of folding the X-shaped connection member;
a second coupling member disposed between the second connection frame and the second main frame to connect the second connection frame and the second main frame and configured to be bent by the operation of folding the X-shaped connection member; and
a locking member installed on at least one of the first and second coupling members and configured to lock or unlock the operation of folding the X-shaped connection member,
wherein the locking member includes a hook portion, at least one of the first and second connection frames includes a protrusion portion, and the operation of folding the X-shaped connection member is locked or unlocked as the hook portion is caught by or released from the protrusion portion.

6. The walking assist apparatus of claim 1, further comprising:
a first extension rod coupled to an upper end of the first connection frame and extending in the forward/rearward direction;
a second extension rod coupled to an upper end of the second connection frame and extending in the forward/rearward direction;
a support member disposed to connect the first and second extension rods and having flexibility; and
an auxiliary band member provided above the support member, connected to the first and second main frames, and having a structure formed convexly forward with respect to the first and second main frames.

7. The walking assist apparatus of claim 1, further comprising:
a first brake lever disposed on a portion of the first main frame disposed below the first handle part and configured to brake the first rear wheel part; and
a second brake lever disposed on a portion of the second main frame disposed below the second handle part and configured to brake the second rear wheel part.
